(19) United States
(12) Patent Application Publication
(10) Pub. No.: US 2003/0121943 A1
(43) Pub. Date: Jul. 3, 2003

(54) Interior automobile securing accessory with several holding positions

(76) Inventor: Sheng-Tao Chou, Keelung City (TW)

Correspondence Address: CHARLES E. BAXLEY, ESQUIRE, Hart, Baxley, Daniels & Holton, 59 John St, 5 FI, New York, NY, 10038, US

(21) Appl. No.: 10/318,532

(22) Filed: Dec. 14, 2002

(30) Foreign Application Priority Data
Dec. 28, 2001 (TW) 090224423

(51) Int. Cl. B60R 7/00

(52) U.S. Cl. 224/275; 224/929

(57) ABSTRACT

An interior automobile securing accessory with several holding positions, comprises a supporting member, which has a stopping section each on the top and bottom of the supporting member, respectively supporting the back of the headrest of the seat, and the back of the seat in the automobile; at least one hook, with one of its ends disposed on the supporting member and the other end coupled to the headrest and the headrest support tubes connected to the back of the seat; the hook can be adjusted in three directions such as the horizontal direction, vertical direction, and the direction extending from the supporting member to the headrest support tube within the range of the supporting member to securely couple the interior automobile accessory to the headrest support tube; at least a placing space disposed on the supporting member at the side other than the back of the seat for the user to place objects into it.

### BACKGROUND OF THE INVENTION

1. Field of the Invention

The present invention relates to an interior automobile securing accessory, which is a rack for placing objects, more particularly an interior automobile securing accessory with at least its upper, middle, and lower sections secured to a headrest/backrest, headrest support tube, and the back of a seat for the secure positioning.

2. Description of the Related Art

There are all kinds of interior automobile accessories fixed to the back of the automobile seat, basically divided into two types: hanging type and embedding type.

The so-called embedding type of the interior automobile accessory shown in FIG. 1 is to reserve an embedding space at the back of the seat or the back of the headrest, and use any coupling member to embed the internal surface (surface other than the external look or using surface) into such space. The operating procedure of the embedding type of interior automobile accessory is very complicated, high cost, only applicable for one model, and irreplaceable, so that its uses and replacement are limited significantly.

The so-called hanging type of the interior automobile accessory as shown in FIG. 2 and FIG. 3 generally uses a ribbon, string, or the like to wrap the two headrest support tubes to hang the automobile accessory at the back of the seat. The interior hanging automobile accessory has two positioning points located on the head support tubes. If the lower positioning point in the car is not set, the end section of the accessory will be loosened and not secured. In addition, the weight of placing object is different from that of the accessory object, and the distribution of weight will be uneven and may tilt the accessory to one side. If the lower positioning point is set, the force exerting position is at the lower section of the back of the seat. Since the back of the seat is wide and flat, it is difficult to find a position for the fixing, therefore adhesive tapes or strings are commonly used to stick or tie the accessory, which will affect the artistic look. In addition, the position of the hanging interior automobile accessory is too low, and it will also affect the usable space in the car.

The inventor of the present invention focuses on the problem of the interior automobile accessory at the backrest and the back of the seat for the improvement, and attains the design of a securing device with several holding positions for easy replacement.

### SUMMARY OF THE INVENTION

The primary objective of the present invention is to provide an interior automobile securing accessory with several holding positions, and the positions of the securing the interior automobile accessory are at the back of the headrest, the headrest support tube, and the back of the seat; and also the hook being latched into the headrest support tube can be adjusted by the X-axis, Y-axis, and Z-axis. The height of placing the interior automobile accessory is appropriate, convenient to use, without affecting the interior use of the car, and the interior automobile accessory is applicable for all kinds of car models with an excellent stability.

The present invention comprises:

a supporting member, having a stopping section each on the top and bottom ends, coupled to the back of the headrest and the back of the automobile seat;

at least one hook, with one of its ends disposed at the supporting member, and the other end coupled to the headrest support tube of the headrest and the back of the seat;

such hook can be adjusted in the horizontal direction, vertical direction, and in the direction of extending the supporting member to the headrest support tube within the range of the supporting member for securely connecting the headrest support tube;

at least one placing space, disposed on the supporting member at the end other than the back of the seat for users to put objects into it.

To make it easier for our examiner to understand the objective of the invention, its structure, innovative features, and performance, we use a preferred embodiment together with the attached drawings for the detailed description of the invention.

### BRIEF DESCRIPTION OF THE DRAWINGS

Other features and advantages of the present invention will become apparent in the following detailed description of the preferred embodiments with reference to the accompanying drawings, in which:

FIG. 1 is a diagram of the appearance of the prior-art interior mobile accessory.

FIG. 2 is a diagram of the appearance of another prior-art interior mobile accessory.

FIG. 3 is a diagram of the appearance of a further prior-art interior mobile accessory.

FIG. 4 is an illustrative diagram of the position of the back of the seat and the back of the headrest and the adjusting direction according to the preferred embodiment of the present invention.

FIG. 5A is a perspective diagram of the first preferred embodiment of the present invention.

FIG. 5B is an illustrative diagram of the application when the back of the seat and the back of the headrest are coupled as shown in FIG. 5A.

FIG. 6A is a perspective diagram of the second preferred embodiment of the present invention.

FIG. 6B is an illustrative diagram of the application when the back of the seat and the back of the headrest are coupled as shown in FIG. 6A.

FIG. 7A is a perspective diagram of the third preferred embodiment of the present invention.

FIG. 7B is an illustrative diagram of the application when the back of the seat and the back of the headrest are coupled as shown in FIG. 7A.

FIG. 8A is a perspective diagram of the third preferred embodiment of the present invention.

FIG. 8B is an illustrative diagram of the application when the back of the seat and the back of the headrest are coupled as shown in FIG. 8A.

FIG. 9A is a perspective diagram of the fifth preferred embodiment of the present invention.

FIG. 9B is an illustrative diagram of the application when the back of the seat and the back of the headrest are coupled as shown in FIG. 9A.

FIG. 10A is a perspective diagram of the sixth preferred embodiment of the present invention.

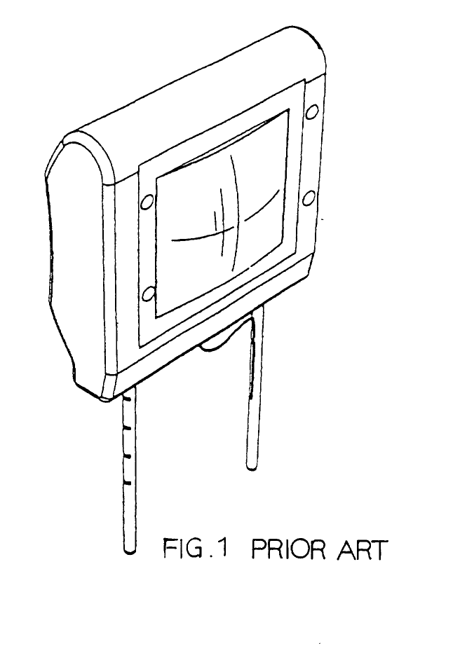

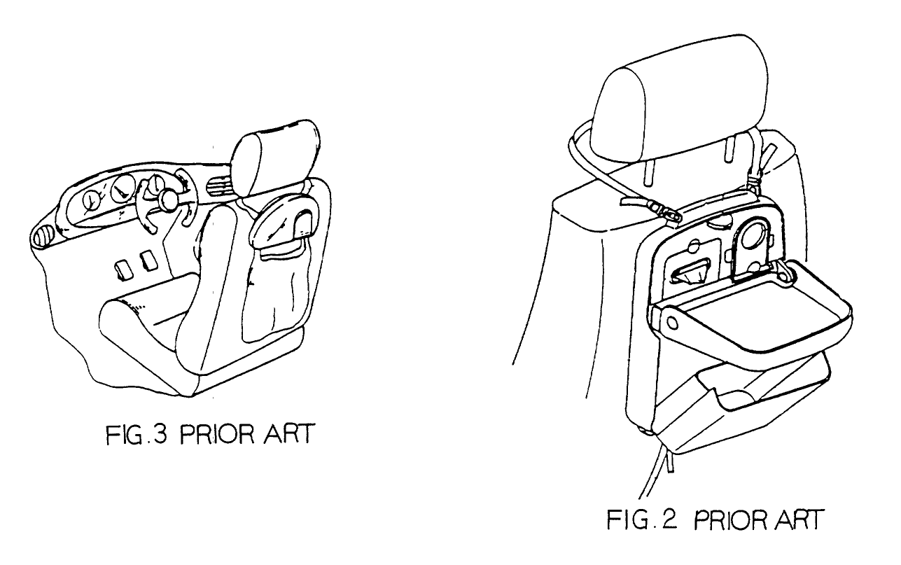

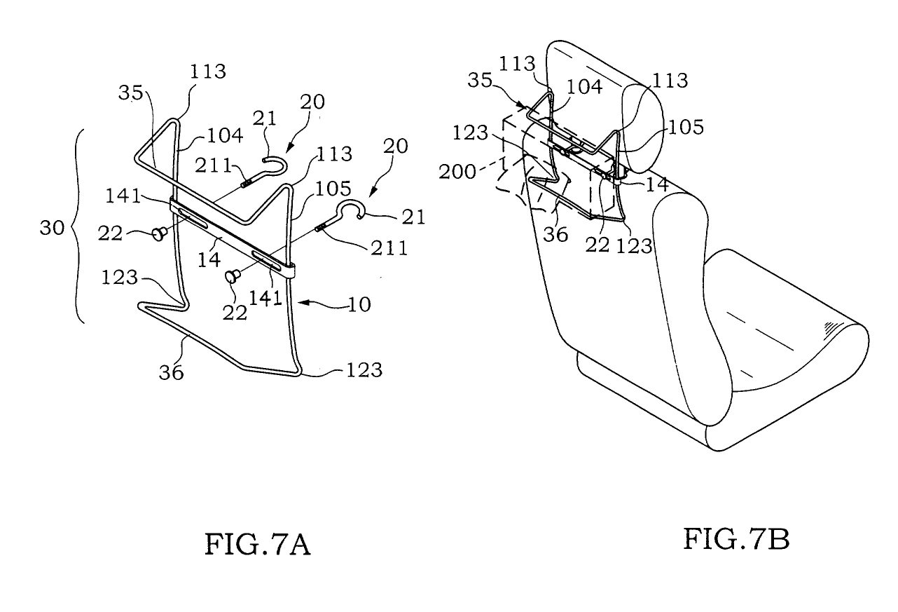

FIG. 7B is an illustrative diagram of the application when the back of the seat and the back of the headrest are coupled as shown in FIG. 7A.

### DETAILED DESCRIPTION OF THE PREFERRED EMBODIMENTS

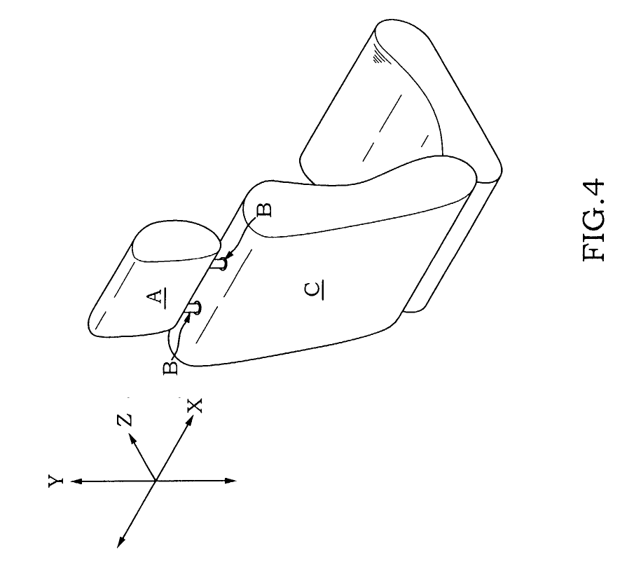

The interior automobile securing accessory of the present invention has several holding positions, which are located at three places: at the back of the headrest of the mobile seat (A), at the headrest support tube (B), and at the back of the seat (C) as shown in FIG. 4. The interior automobile accessory of the present invention comprises:

a supporting member 10, having at least one stopping section 11, 12 at the top and bottom ends of the supporting member 10, respectively coupled to the back of the headrest A and the back of the seat C; such supporting member 10 can be adjusted vertically in the Y-axis direction of the back of the seat C such that the two stopping sections 11, 12 can be securely coupled to the back of the headrest A and the back of the seat A;

at least one hook 20, one end of the hook being disposed at the supporting member 10 and the other end coupled to the headrest support tube B, the hook 20 having an adjustable feature that the hook can be shifted in the X-axis and Y-axis directions (that is the horizontal direction and the vertical direction) of the supporting member 10 within its range, and the hook also allowing the adjustment of the distance from the supporting member 10 to the headrest support tube B along the Z-axis, so that the hook 20 being securely coupled to the headrest support tube B;

at least a placing space 30, disposed on the supporting member 10 on the side other than the back of the seat;

by means of the foregoing structure, at least the two stopping sections 11, 12 and the hook 20 of the interior automobile accessory with respect to the back of the headrest A, the headrest support tube B, and the back of the seat constitute three holding positions at the upper, middle, and lower sections; and the elasticity of the material of the headrest and the back of the seat lets the stopping section 11, 12 slightly subside into the headrest and the back of the seat, and the friction on the surface of the headrest and the back of the seat also helps the stopping section 11, 12 to be fixed into the position, and thus the interior automobile accessory can be secured to the position better.

While the present invention has been described in connection with what is considered the most practical and preferred embodiments, it is understood that this invention is not limited to the disclosed embodiments but is intended to cover various arrangements included within the spirit and scope of the broadest interpretations and equivalent arrangements.

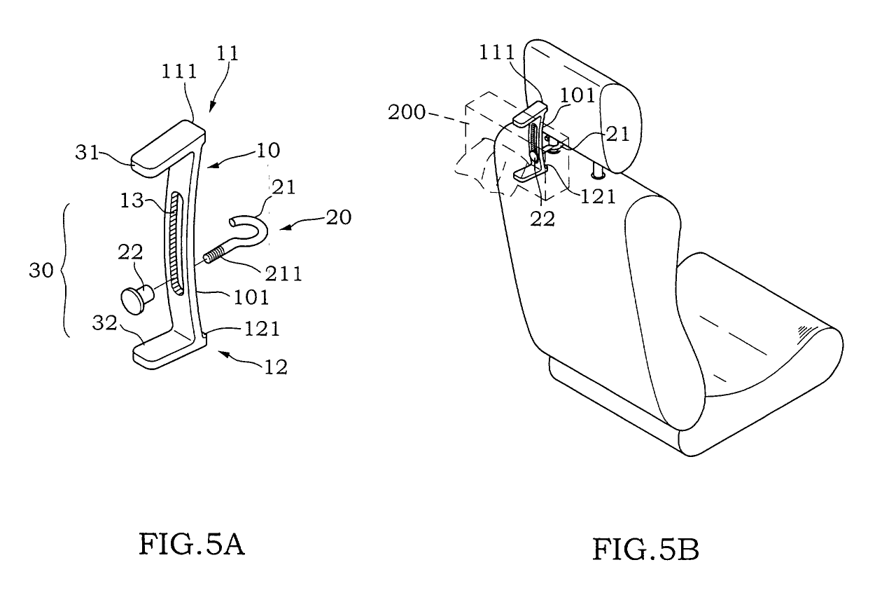

Refer to FIG. 5A and FIG. 5B for the first preferred embodiment of the present invention, which is a single integrated interior automobile accessory. The supporting member 10 of the interior automobile accessory is a bracket substantially in the shape of a long bar, and a stopping section is disposed each at the upper and lower ends individually supporting the back of the headrest A and the back of the seat C. A long hole 13 is disposed on the bracket, and a hook is disposed in the long hole 13. After the stopping section 111, 121 are secured in the position, the hook 20 can be adjusted along the Y-axis to get into an appropriate position with respect to the headrest support tube B.

The hook 20 is a hook body 21 with thread section 211 at one of its ends. The hook body 21 is coupled to the headrest support tube B; turning a knob 22 will adjust the hook 29 along the Z-axis direction to couple to hook to the headrest support tube B in an appropriate distance.

The placing space 30 in the car is formed by extending two clipping plates 31, 32 from the upper and lower ends of the bracket 101, and the size of the placing space 30 has no particular limitation in this embodiment, and basically the size of the placing space 30 should allow the two clipping plates 31, 32 to clip and balance the objects in the placing space 30. In the embodiment, a tissue box 200 is put into the placing space 30.

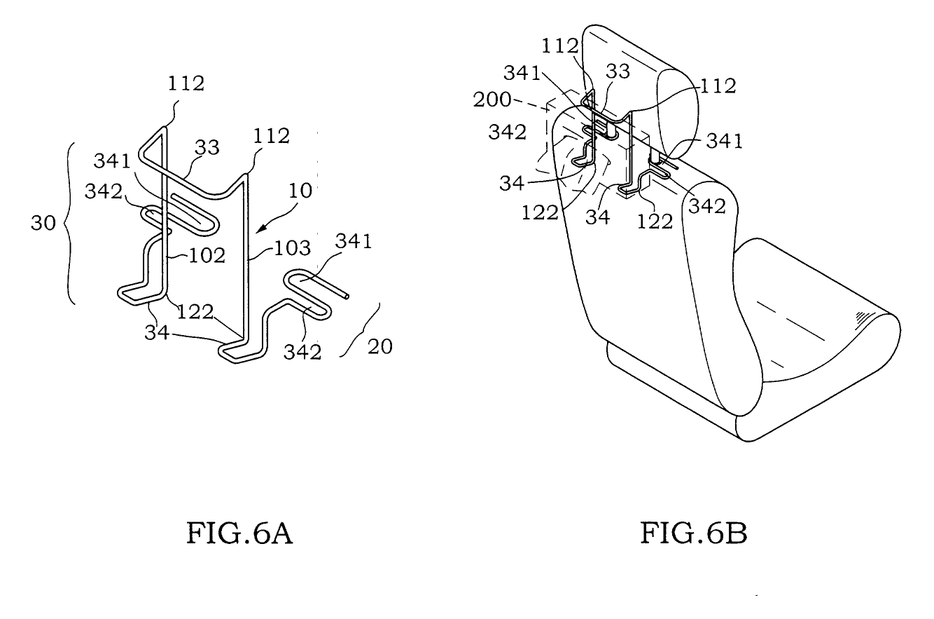

Refer to FIG. 6A and FIG. 6B for the second preferred embodiment of the present invention, which is a frame-rod type of interior automobile accessory. The supporting member 10 is composed of two vertical rods 102, 103, and the two vertical rods 102, 103 have an upper rack 33 and a lower rack 34 each on the upper end and lower end of the two vertical rods 102, 103 respectively supporting the back of the headrest A and the back of the seat C. The upper and lower racks 33, 34 have a placing space 30 in between, in which a tissue box can be placed. The end of the lower rack 34 is bent towards the back of the seat to form a first bent space 341 and a second bent space 342, and the hook 20 is formed from the first bent space 341 and the second bent space 342. The first bent space 341 is used to clip the headrest support tube B, and the second bent space 342 is elastically opened and shut to meet the distance between the vertical rod 102, 103 to the headrest support tube B, so that the first bent space 341 is coupled to the headrest support rod B. Therefore, the second bent space 342 is a key structure for controlling the adjustment of the hook 20 along the Z-axis. The first bent space 341 has an appropriate width for creating a distance for adjustment within its width, and the headrest support tube B can be located in any position within its width to meet the distance of the two headrest support tubes B.

Refer to FIG. 7A and FIG. 7B for the third preferred embodiment of the present invention, which is also a frame-rod type of interior automobile accessory. The supporting member 10 is composed of the two vertical rods 104, 105, and a stopping section 113, 123 each disposed on the upper and lower ends of the supporting member 10 respectively supporting the back of headrest A and the back of the seat C. The upper and lower ends of the two vertical rods 104, 105 each forming an upper rack 35 and a lower rack 36 in the same direction of the bending, and a placing space 30 is formed between the upper rack 35 and the lower rack 36. A transversal plate 14 is disposed across the two vertical rods 104, 105, and two long holes 141 are disposed on the transversal plate 14, and the long hole 141 has two hooks 20, and the transversal plate 14 can be adjusted within the two vertical rods 104, 105 such that the hook can be adjusted along the Y-axis, and the long hole 141 allows the hook 20 to make adjustment along the X-axis. The hook 20 is the same as the first embodiment, which can make adjustment along the Z-axis direction.

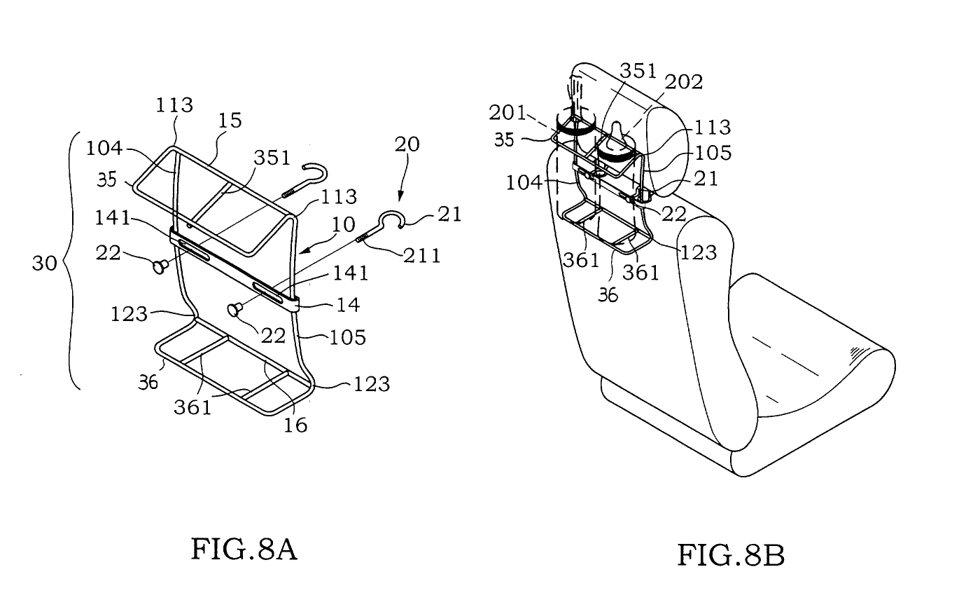

Refer to FIG. 8A and FIG. 8B for the fourth preferred embodiment of the present invention, which is also a frame-rod type of interior automobile accessory. The structure is derived from the third embodiment, mainly having a link rod 15, 16 between the corresponding stopping sections 113, 123 on the left and right sides, and a plurality of isolating rods 351, 361 between the upper and lower racks 34, 35 and the link rod 15, 16 to divide the placing space 30 into several separated areas such that several tissue cylinders 201 or milk bottles 202 can be put vertically into these areas.

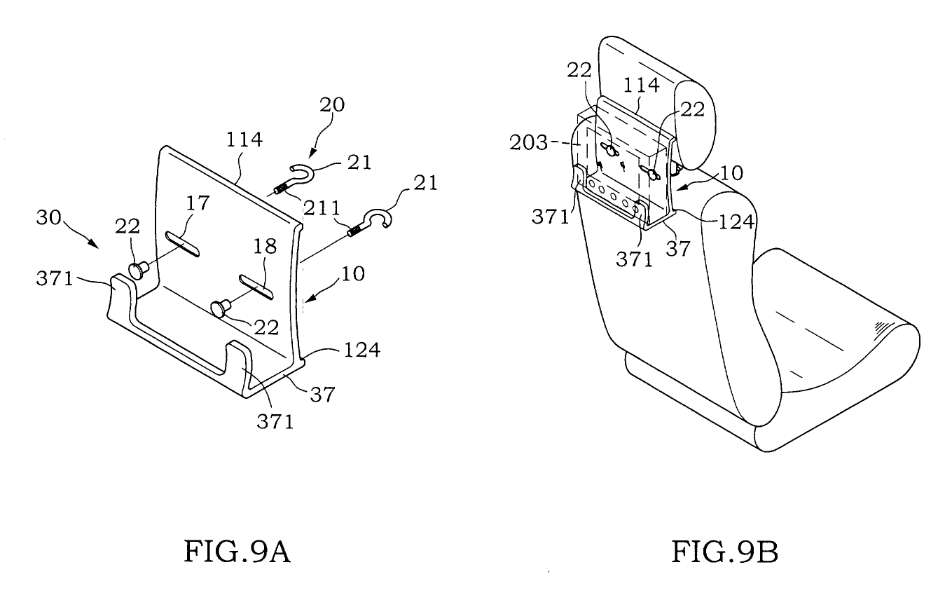

Refer to FIG. 9A and FIG. 9B for the fifth preferred embodiment of the present invention, which is an interior automobile accessory for putting the LCD display of the car. The supporting member 10 is a solid board, also having two stopping sections 114, 124, respectively supporting the back of the headrest A and the back of the seat C. The supporting member 10 has a lower rack 37 at the bending corner of the bottom, and a placing space 30 is disposed in front of the supporting member 10 above the lower rack 37. The placing space 30 is for placing the LCD display 203 of the car. To meet the size requirement of different kinds of LCD displays 203, the placing space should be open at the top and both left and right sides. Two buckles 371 are disposed each at the ends of the lower rack 37 to clip and mount the LCD display 203. The supporting member 10 has two long holes 17, 18, and a hook 20 is disposed in the long hole 17, 18. The structure of the long holes 17, 18 and the hook 20 are the same as those described in the previous embodiments.

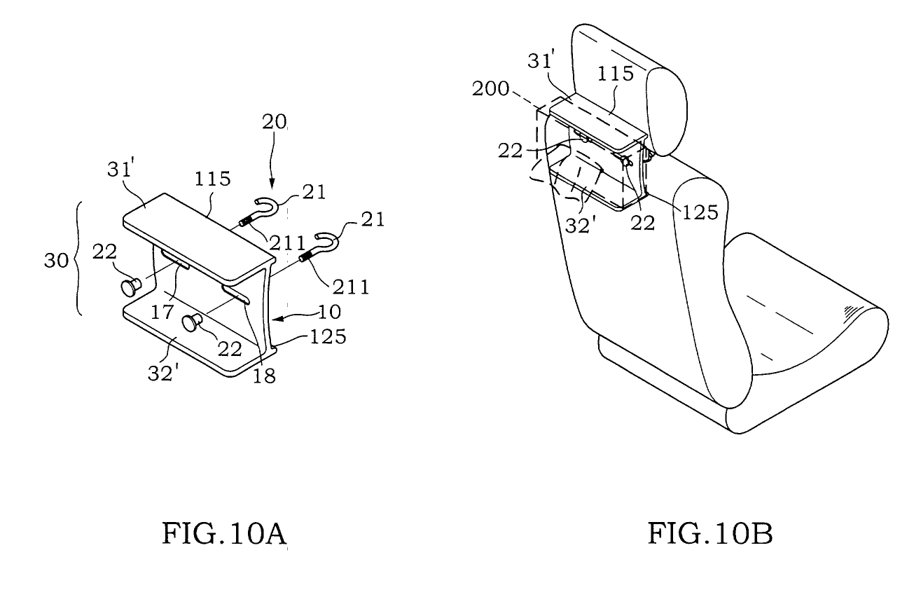

Refer to FIG. 10A and FIG. 10B for the sixth preferred embodiment of the present invention. The supporting member 10 of the interior automobile accessory is also a solid board, and a stopping section 115, 125 is disposed each on the upper and lower backs of the supporting member 10, respectively supporting the back of the headrest A and the back of the seat C. Two long holes 17, 18 are disposed on the supporting member 10, and a hook 20 is disposed in the long hole 17, 18. The structure and action between the long hole 17, 18 and the hook 20 are the same as those described in the previous embodiments. The placing space of the interior automobile accessory is composed of two clipping boards 31′, 32′ extended from the upper and lower ends.

There are two key designing points of the present invention: one is to design the holding position of the interior automobile accessory at three places such as the back of the headrest A, the headrest support tube B, and the back of the seat C and the other one is to design an adjustment of the hook 20 along the three axes such as the X-axis, Y-axis, and Z-axis. The advantages of such design rely on the following:

1. The height of the interior automobile accessory is appropriate, convenient to access the object, without affecting the usable space inside the car.

2. Since the distance between the two headrest support tubes B and the distance between the headrest support tube to the margin of the back of the seat are different for different models of cars, therefore the hook 20 is designed in such a way that it can be adjusted along the three axes: X-axis, Y-axis, and Z-axis, so that the interior automobile accessory of the present invention can be used in different models of cars.

3. The hook 20 is fixed to the headrest support rod B, and the entire interior automobile accessory can obtain a preliminary fixing force to prevent it from falling off. The supporting and stopping connection of the stopping sections 11, 12 of the upper and lower sections and the back of the headrest A and the back of the seat C also increases the stability of the interior automobile accessory, so that the hook will not be loosened or tilted. Since such arrangement has sufficient stability, therefore in addition to placing general items into the interior automobile accessory, the interior automobile accessory of the present invention can mount the LCD display 203 or other expensive automobile equipment that requires a stable protection.

4. The design of the present invention will not affect the adjustment of the inclination of the back of the seat, or the maintenance of a suitable and comfortable angle of the seat, such that the back of the headrest A, headrest support tube B, and the back of the seat C can keep an excellent supporting and stopping connection with the interior automobile accessory.

While the invention has been described by way of example and in terms of a preferred embodiment, it is to be understood that the invention is not limited thereto. To the contrary, it is intended to cover various modifications and similar arrangements and procedures, and the scope of the appended claims therefore should be accorded the broadest interpretation so as to encompass all such modifications and similar arrangements and procedures.

What is claimed is:

1. An interior automobile securing accessory with several holding positions, comprising:
a supporting member, having a stopping section each at the top and bottom of the supporting member, respectively coupling to the back of a headrest and the back of a seat;
at least one hook, with one of its ends disposed on the supporting member, and the other end coupled to the headrest and a headrest support tube connected to the back of the seat; the hook capable of being adjusted along a horizontal direction, a vertical direction, and in a direction of extending the supporting member to the headrest support tube to secure the headrest support tube to the hook;
at least one placing space, disposed on the supporting member at the side other than the back of the seat for user to place object into the space.

2. An interior automobile securing accessory with several holding positions as claimed in claim 1, wherein said supporting member being a plate in the shape of a long bar, and the plate having a stopping section each on the upper and lower end of the plate respectively supporting the back of the headrest and the back of the seat, and having a long hole and a hook being disposed in the long hole such that the hook being adjusted in a vertical direction; two clipping plates, each disposed at the turning corner of the upper and lower ends of the plate, and a placing space being disposed between the two clipping plates.

3. An interior automobile securing accessory with several holding positions as claimed in claim 2, wherein said hook having a hood body with a thread section at one end, and a knob with inner thread being disposed in the thread section; the hook body coupled to the headrest support tube, such that the hook body being adjusted in the direction from the supporting member to the headrest support tube as the knob rotates and the hooked object being held between the supporting member and the headrest support tube.

4. An interior automobile securing accessory with several holding positions as claimed in claim 1, wherein said supporting member being composed of two vertical rods, a stopping section each disposed on the upper end and the lower ends of the vertical rod respectively supporting the back of the headrest and the back of the seat; the two vertical rods at their turning corner of the upper end and lower end having an upper rack and a lower rack to form a placing space between the upper and lower racks; the hooked object forming a first bent space and a second bent space at the lower rack by the end extending to the direction of the back of the seat; the first bent space hooking to the headrest support tube, and the second bent space being elastically opened and shut to hook the headrest support tube by the first bent space.

5. An interior automobile securing accessory with several holding positions as claimed in claim 1, wherein said first bent space having a predetermined width, and the headrest support tube being in any position with its width such that the hooked object being adjusted in the horizontal direction.

6. An interior automobile securing accessory with several holding positions as claimed in claim 1, wherein said supporting member being composed of two vertical rods, having a stopping section each on an upper end and a lower end of the vertical rod, respectively supporting the back of a headrest and the back of a seat; the two vertical rod forming an upper rack and a lower rack at the turning corner of its upper end and lower end, and a placing space being formed by the upper and lower rack; a transversal plate being disposed across the two vertical rods, and two long holes being disposed on the transversal plate, and a hooked object being disposed in the long hole.

7. An interior automobile securing accessory with several holding positions as claimed in claim 6, wherein said transversal plate being adjusted on the two vertical rods such that the hooked object being adjusted in the vertical direction; the long hole being used for adjusting the hooked object along the horizontal direction.

8. An interior automobile securing accessory with several holding positions as claimed in claim 6, wherein said hooked object being a hook body with thread section, and the hook thread section having a know with internal threads; the hook body being coupled to the headrest support tube, such that the hook object being hooked to the headrest support tube as the knob rotates.

9. An interior automobile securing accessory with several holding positions as claimed in claim 6, wherein said stopping section on both of its left and right sides having a link rod and a plurality of isolating rods on the upper and lower racks to separate the placing space.

10. An interior automobile securing accessory with several holding positions as claimed in claim 1, wherein said supporting member being a solid plate with two stopping sections respectively supporting the back of a headrest and the back of a seat; the supporting member at the corner of its bottom having a lower rack, and the placing space being disposed in front of the supporting member; two buckles being disposed at the end of the lower rack to clip the object in the placing space; two long holes being disposed on the supporting member, and a hooked object being disposed in the long hole.

11. An interior automobile securing accessory with several holding positions as claimed in claim 10, wherein said object being the LCD display of the car.

12. An interior automobile securing accessory with several holding positions as claimed in claim 10, wherein said hooked object being a hook body with a thread section at its end, and the thread section having a knob with internal threads; the hooked body being coupled to the headrest support tube such that the hooked object being hooked to the headrest support tube as the knob rotates.

13. An interior automobile securing accessory with several holding positions as claimed in claim 1, wherein said supporting member being a solid plate, and a stopping section each being disposed on the upper and lower sections of the back of the supporting member respectively supporting the back of the headrest and the back of the seat; the supporting member having two long holes, and a hooked object being disposed in the long hole; the placing space of the interior automobile accessory being constituted by two clipping boards extending from the upper and lower ends of the supporting member.

14. An interior automobile securing accessory with several holding positions as claimed in claim 13, wherein said hooked object having a hooked object with a thread section at its end, and a knob with internal thread being disposed at the thread section; the hooked body being hooked to the headrest support tube such that the hooked object being hooked to the headrest support tube as the knob rotates.
